(19) United States
(12) Patent Application Publication
(10) Pub. No.: US 2018/0018434 A1
(43) Pub. Date: Jan. 18, 2018

(54) NOTIFICATION OF HEALTHCARE PROFESSIONAL AVAILABILITY

(71) Applicant: International Business Machines Corporation, Armonk, NY (US)

(72) Inventors: Ivory R.K. Assan, Atlanta, GA (US); Denise A. Bell, Austin, TX (US); Troy G. Bjerke, Austin, TX (US); Sandra L. Tipton, Austin, TX (US)

(21) Appl. No.: 15/207,967

(22) Filed: Jul. 12, 2016

(51) Int. Cl. G06F 19/00; G06F 21/62

(52) U.S. Cl. CPC G06F 19/327; G06F 19/3406; G06F 21/6218

(57) ABSTRACT

In an approach to determining doctor availability, one or more computer processors receive a request for doctor availability in a patient's hospital room from a patient advocate. The one or more computer processors determine a current location of a doctor's mobile computing device. The one or more computer processors determine, based, at least in part, on the current location of the doctor's mobile computing device, an arrival time of the doctor in the patient's hospital room. The one or more computer processors send a notification to the patient advocate of the arrival time of the doctor in the patient's hospital room.

### BACKGROUND OF THE INVENTION

The present invention relates generally to the field of healthcare appointment scheduling, and more particularly to notification of healthcare professional availability.

A typical healthcare system includes a number of participants, such as patients, doctors, hospitals and insurance carriers. Many patients have a support network made up of numerous individuals. For example, a patient's support network could comprise parents, siblings, extended family members and friends. While a typical healthcare system integrates the patients, doctors, hospitals and insurance carriers, individuals in the support network are not fully integrated and included in the care of the patient. Including a patient's support network in the patient care process leads to both better health outcomes and lower costs for the healthcare system.

Mobile phone tracking is the ascertaining of the position or location of a mobile phone, whether stationary or moving. Localization may occur either via multilateration of radio signals between (several) cell towers of the network and the phone, i.e., a navigation technique based on the measurement of the difference in distance to two stations at known locations that broadcast signals at known times, or simply via a global positioning system (GPS). To locate a mobile phone using multilateration of radio signals, the mobile phone must emit at least the roaming signal to contact the next nearby antenna tower, but the process does not require an active call.

### SUMMARY

Embodiments of the present invention disclose a method, a computer program product, and a system for determining doctor availability. The method may include one or more computer processors receiving a request for doctor availability in a patient's hospital room from a patient advocate. The one or more computer processors determine a current location of a doctor's mobile computing device. The one or more computer processors determine, based, at least in part, on the current location of the doctor's mobile computing device, an arrival time of the doctor in the patient's hospital room. The one or more computer processors send a notification to the patient advocate of the arrival time of the doctor in the patient's hospital room.

### BRIEF DESCRIPTION OF THE DRAWINGS

FIG. 1 is a functional block diagram illustrating a distributed data processing environment, in accordance with an embodiment of the present invention;

FIG. 2 is a flowchart depicting operational steps of a location notification program, on a server computer within the distributed data processing environment of FIG. 1, for notifying a patient advocate of an estimated time of arrival of a doctor in the patient's hospital room, in accordance with an embodiment of the present invention; and

FIG. 3 depicts a block diagram of components of the server computer executing the location notification program within the distributed data processing environment of FIG. 1, in accordance with an embodiment of the present invention.

### DETAILED DESCRIPTION

Coordination of communication with healthcare providers, such as doctors, by an advocate of a patient in a hospital setting can be difficult when the doctors' visits with the patient are brief and unscheduled. In general, a patient advocate, such as a family member, may have to spend hours in the patient's room in order to get a chance to meet directly with the doctor on rounds, and a random, brief break from the room may result in the patient advocate missing the doctor's visit. Embodiments of the present invention recognize that communication with an attending doctor may be improved by providing a tool that uses geospatial information from the doctor's device and geospatial information from the patient advocate's device to notify the patient advocate when the doctor will likely arrive in the patient's room. Implementation of embodiments of the invention may take a variety of forms, and exemplary implementation details are discussed subsequently with reference to the Figures.

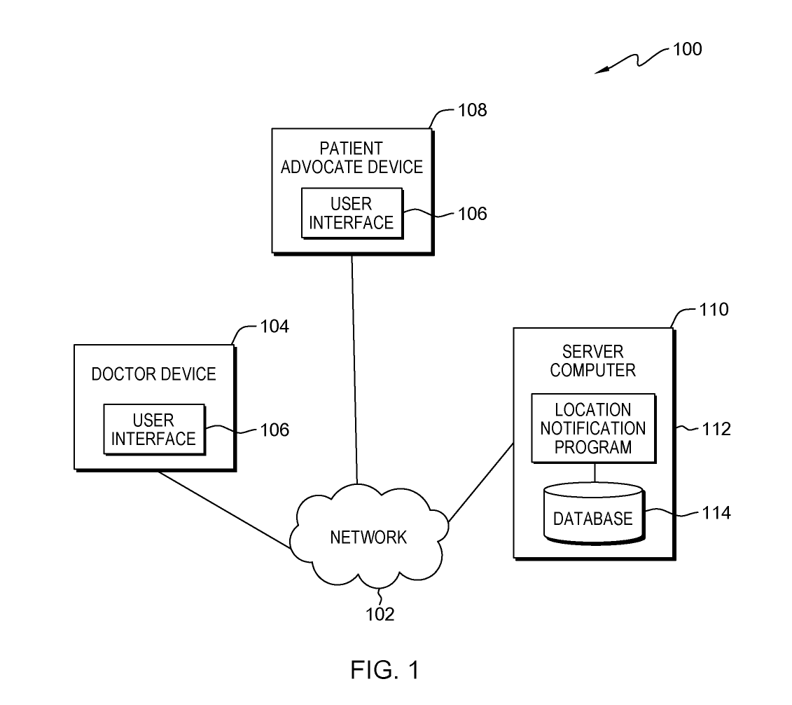

FIG. 1 is a functional block diagram illustrating a distributed data processing environment, generally designated 100, in accordance with one embodiment of the present invention. The term “distributed” as used in this specification describes a computer system that includes multiple, physically distinct devices that operate together as a single computer system. FIG. 1 provides only an illustration of one implementation and does not imply any limitations with regard to the environments in which different embodiments may be implemented. Many modifications to the depicted environment may be made by those skilled in the art without departing from the scope of the invention as recited by the claims.

Distributed data processing environment 100 includes doctor device 104, patient advocate device 108, and server computer 110, all interconnected over network 102. Network 102 can be, for example, a telecommunications network, a local area network (LAN), a wide area network (WAN), such as the Internet, or a combination of the three, and can include wired, wireless, or fiber optic connections. Network 102 can include one or more wired and/or wireless networks that are capable of receiving and transmitting data, voice, and/or video signals, including multimedia signals that include voice, data, and video information. In general, network 102 can be any combination of connections and protocols that will support communications between doctor device 104, patient advocate device 108, server computer 110, and other computing devices (not shown) within distributed data processing environment 100.

Doctor device 104 and patient advocate device 108 can each be a laptop computer, a tablet computer, a smart phone, or any programmable electronic mobile device capable of communicating with various components and devices within distributed data processing environment 100, via network 102. In general, doctor device 104 and patient advocate device 108 each represent any programmable electronic mobile device or combination of programmable electronic mobile devices capable of executing machine readable program instructions and communicating with other computing devices (not shown) within distributed data processing environment 100 via a network, such as network 102. Doctor device 104 and patient advocate device 108 each include an instance of user interface 106.

User interface 106 provides an interface to location notification program 112 on server computer 110 for a user of doctor device 104 or a user of patient advocate device 108. In one embodiment, user interface 106 may be a graphical user interface (GUI) or a web user interface (WUI) and can display text, documents, web browser windows, user options, application interfaces, and instructions for operation, and include the information (such as graphic, text, and sound) that a program presents to a user and the control sequences the user employs to control the program. In another embodiment, user interface 106 may also be mobile application software that provides an interface between a user of doctor device 104 or a user of patient advocate device 108 and server computer 110. Mobile application software, or an “app,” is a computer program designed to run on smart phones, tablet computers and other mobile devices. User interface 106 enables the user of doctor device 104 to register with and configure location notification program 112 to enable tracking of the location of doctor device 104. User interface 106 may also enable the user of doctor device 104 to provide a schedule to location notification program 112. User interface 106 enables the user of patient advocate device 108 to register with and configure location notification program 112 to receive notifications from server computer 110 regarding the availability of the user of doctor device 104.

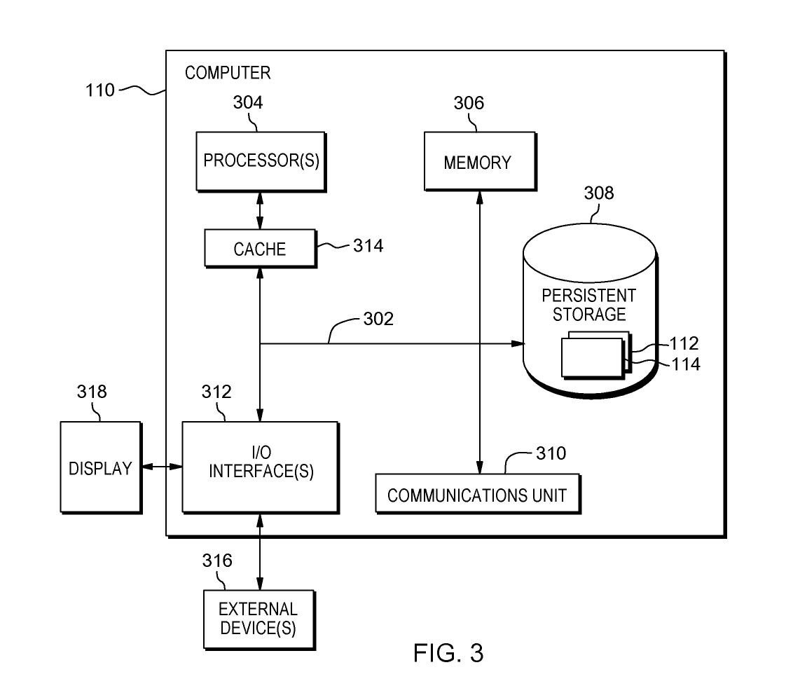

Server computer 110 can be a standalone computing device, a management server, a web server, a mobile computing device, or any other electronic device or computing system capable of receiving, sending, and processing data. In other embodiments, server computer 110 can represent a server computing system utilizing multiple computers as a server system, such as in a cloud computing environment. In another embodiment, server computer 110 can be a laptop computer, a tablet computer, a netbook computer, a personal computer (PC), a desktop computer, a personal digital assistant (PDA), a smart phone, or any other programmable electronic device capable of communicating with doctor device 104, patient advocate device 108, and other computing devices (not shown) within distributed data processing environment 100 via network 102. In another embodiment, server computer 110 represents a computing system utilizing clustered computers and components (e.g., database server computers, application server computers, etc.) that act as a single pool of seamless resources when accessed within distributed data processing environment 100. Server computer 110 includes location notification program 112 and database 114. Server computer 110 may include internal and external hardware components, as depicted and described in further detail with respect to FIG. 3.

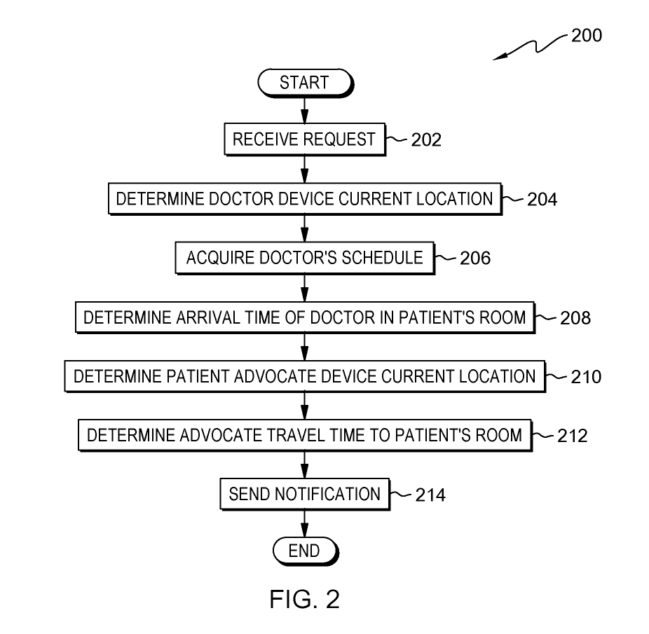

Location notification program 112 facilitates direct communication between a doctor, or other healthcare provider, and a patient's advocate by notifying the patient's advocate of a time when the doctor is expected to arrive in the patient's hospital room during the doctor's rounds and be available for a discussion. Location notification program 112 receives a request from a patient's advocate for a notification. Location notification program 112 determines the current location of the doctor's device. Location notification program 112 acquires the doctor's schedule and determines an estimated arrival time in the patient's room based on established patterns of the doctor's movements, as well as the current location of the device and the doctor's schedule. Location notification program 112 determines the current location of the patient advocate's device and determines the amount of time needed to travel from the current location to the patient's room. Location notification program 112 notifies the patient advocate of the estimated arrival time of the doctor with sufficient notice to enable the patient advocate to travel to the patient's room and intercept the doctor. Location notification program 112 is depicted and described in further detail with respect to FIG. 2.

Database 114 is a repository for data used by location notification program 112. In the depicted embodiment, database 114 resides on server computer 110. In another embodiment, database 114 may reside elsewhere within distributed data processing environment 100 provided location notification program 112 has access to database 114. A database is an organized collection of data. Database 114 can be implemented with any type of storage device capable of storing data and configuration files that can be accessed and utilized by server computer 110, such as a database server, a hard disk drive, or a flash memory. Database 114 stores data associated with the historical movement of doctor device 104, including observed patterns. Database 114 also stores metadata associated with users of user interface 106 such as registration and configuration data of doctor device 104 and patient advocate device 108. Database 114 may also store doctors' schedules and calendars.

FIG. 2 is flowchart 200 depicting operational steps of location notification program 112, on server computer 110 within distributed data processing environment 100 of FIG. 1, for notifying a patient advocate of an estimated time of arrival of a doctor in the patient's hospital room, in accordance with an embodiment of the present invention.

Location notification program 112 receives a request (step 202). A patient advocate wants to communicate directly with the patient's doctor while the doctor visits the patient on rounds. A patient advocate can include a family member, friend, guardian, or anyone else responsible for making healthcare decisions on behalf of the patient or who otherwise would like to meet with the patient's doctor. In addition, a patient advocate can include others that may need to speak directly to the patient's doctor about the patient's care, such as a nurse, a physical therapist, a counselor, or a member of the clergy. In one embodiment, when the patient advocate accesses user interface 106 on patient advocate device 108 and registers with location notification program 112, location notification program 112 receives the registration as a request for notification of doctor availability, i.e., an estimated time of arrival of a doctor in the patient's hospital room. In another embodiment, location notification program 112 receives a request when the patient advocate launches user interface 106 at a time other than the initial registration. In one embodiment, location notification program 112 presents a dropdown box, via user interface 106, from which the patient advocate can choose the doctor(s) for which notification is requested. In another embodiment, the patient advocate can type in the doctor's name via a keypad associated with patient advocate device 108. In one embodiment, the request includes instructions and appropriate access for location notification program 112 to use the current location of patient advocate device 108 when determining travel time to the patient's room. In one embodiment, the request includes the patient's hospital room number for location notification program 112 to use when determining an estimated time of arrival of a doctor or the patient advocate in the patient's room. In an embodiment, the request includes a choice of confidence level. For example, if the patient advocate only wants to be notified of the estimated doctor arrival time when location notification program 112 determines there is at least an 85 percent chance that the estimate is correct, then the patient advocate can type in or choose 85 percent from a dropdown box. In another embodiment, instead of choosing a confidence level ahead of time, the patient advocate can specify that location notification program 112 includes the computed confidence level in the notification. In an embodiment, location notification program 112 computes a confidence level using known methods. In another embodiment, location notification program 112 computes a confidence level as described below with respect to step 208.

Location notification program 112 determines the doctor device current location (step 204). Location notification program 112 determines the location of doctor device 104 via one of a plurality of location tracking technologies known in the art. For example, location notification program 112 may use a global positioning system (GPS) capability integrated within doctor device 104 to determine the location of doctor device 104. In another example, location notification program 112 may use an interior positioning system in use in the hospital to determine the location of doctor device 104 within the hospital.

Location notification program 112 acquires the doctor's schedule (step 206). In one embodiment, the doctor stores a schedule or calendar in database 114 and location notification program 112 retrieves the schedule from database 114. In another embodiment, the doctor's schedule may be included in a hospital scheduling system included in distributed data processing environment 100 (not shown), which location notification program 112 can access via network 102 to retrieve the doctor's schedule. In a further embodiment, the doctor can push the schedule to location notification program 112 via user interface 106. The doctor's schedule may include appointments, surgeries, rounds, meetings, and other work-related activities. The doctor's schedule may be limited to work hours or the doctor's schedule may also include personal time.

Location notification program 112 determines an arrival time of the doctor in the patient's room (step 208). When the doctor registers doctor device 104 with location notification program 112, via user interface 106, the doctor enables location notification program 112 to track the location of doctor device 104. In one embodiment, the doctor may configure location notification program 112 to only track doctor device 104 during particular hours of a day. Location notification program 112 detects patterns of geospatial movement of doctor device 104 over time via machine learning and pattern recognition techniques, as would be appreciated by one with skill in the art. Machine learning explores the study and construction of algorithms that can learn from and make predictions on data. Such algorithms operate by building a model from example inputs in order to make data-driven predictions or decisions expressed as outputs, rather than following strictly static program instructions. Within the field of data analytics, machine learning is a method used to devise complex models and algorithms that lend themselves to prediction. These analytical models allow researchers, data scientists, engineers, and analysts to produce reliable, repeatable decisions and results and to uncover hidden insights through learning from historical relationships and trends in the data. Pattern recognition is a branch of machine learning that focuses on the recognition of patterns and regularities in data. Pattern recognition systems may be trained from labeled “training” data (supervised learning), but when no labeled data are available, other algorithms can be used to discover previously unknown patterns (unsupervised learning). For example, by monitoring the location of doctor device 104, location notification program 112 may detect that the doctor typically departs home and heads for the hospital every Monday, Tuesday, and Thursday at 10:00 a.m., and upon arrival at the hospital, the doctor begins rounds. In another example, location notification program 112 may detect that the doctor typically begins rounds on the hospital's second floor and moves to the third floor after approximately 45 minutes. In a further example, location notification program 112 may detect that when the doctor enters the surgical ward, the doctor typically stays there for three hours. In yet another example, location notification program 112 may determine that the doctor is historically fifteen minutes late to a majority of appointments on the schedule. Location notification program 112 stores the learned patterns in database 114. By retrieving the doctor's learned patterns and combining the patterns with the current location of doctor device 104, location notification program 112 can estimate an arrival time of the doctor in the patient's room within a confidence level computation. In one embodiment, the patient advocate defines the confidence level desired for notification. In another embodiment, location notification program 112 includes a default confidence level. Location notification program 112 may also combine the learned patterns and current location with the acquired schedule to estimate an arrival time of the doctor.

In one embodiment, location notification program 112 estimates a range of time in which the doctor will arrive in the patient's room. For example, location notification program 112 may determine the doctor will arrive between 3:00 p.m. and 4:00 p.m. In another embodiment, location notification program 112 may estimate a time of arrival with confidence levels. For example, location notification program 112 may determine, based on historical patterns, the doctor's schedule and the doctor's current location, that there is a 90 percent probability that the doctor will arrive at 3:00 p.m. In one embodiment, the doctor can manually configure, via user interface 106, travel times to the hospital or to the patient's room from various locations. For example, the doctor can enter a travel time of 30 minutes from home to the hospital, 15 minutes from the office to the hospital, and ten minutes from the surgical ward to patient rooms on the third floor. In another embodiment, location notification program 112 can use known navigation techniques combined with dynamic data to determine the arrival time of the doctor in the patient's room. Dynamic data is information that is asynchronously changed as further updates to the information become available. Location notification program 112 may access sources of dynamic data, such as traffic or weather reports, to determine the doctor's arrival time. For example, if the doctor is at a golf course, then location notification program 112 can account for current traffic status on the route to determine the travel time to the hospital. In another example, location notification program 112 may determine the arrival time may be delayed if there is bad weather in the area by accessing current weather data.

Location notification program 112 determines the patient advocate device current location (step 210). As discussed with respect to the location of doctor device 104, location notification program 112 determines the location of patient advocate device 108 via one of a plurality of location tracking technologies known in the art. For example, location notification program 112 may use a global positioning system (GPS) capability integrated within patient advocate device 108 to determine the location of patient advocate device 108.

Location notification program 112 determines the advocate's travel time to the patient's room (step 212). Based on the current location of patient advocate device 108, location notification program 112 determines the time required for the patient advocate to travel to the patient's room. In one embodiment, the patient advocate can manually configure, via user interface 106, travel times to the patient's room from various locations. For example, the patient advocate can enter a travel time of 20 minutes from home to the patient's room, a travel time of eight minutes from the hospital entrance to the patient's room, and a travel time of three minutes from the hospital cafeteria to the patient's room. In another embodiment, location notification program 112 can use known navigation techniques to determine the length of travel time. For example, if the patient advocate is at home or in a hotel, then location notification program 112 can account for current traffic status on the route to determine the travel time. In another example, if the patient advocate is in the hospital cafeteria, then location notification program 112 can calculate time required to move from the cafeteria to the patient's room. If patient advocate device 108 is currently in the patient's room, then location notification program 112 determines the travel time is zero.

Location notification program 112 sends a notification (step 214). Location notification program 112 sends a notification to patient advocate device 108, via user interface 106, to alert the patient advocate of the estimated arrival time of the doctor in the patient's room. In one embodiment, location notification program 112 sends the notification based on the determined travel time of the patient advocate to the patient's room. For example, if location notification program 112 determined it will take the patient advocate 20 minutes to travel to the patient's room, then location notification program 112 sends the notification 20 minutes before the estimated doctor arrival time. In another embodiment, location notification program 112 may send the notification as soon as location notification program 112 determines the doctor arrival time. In the embodiment, location notification program 112 may include the patient advocate's travel time in the notification. For example, location notification program 112 may send a notification that says “The doctor is estimated to be in the patient's room between 3:00 p.m. and 4:00 p.m. Plan to leave your current location by 2:40 p.m.” In an embodiment where location notification program 112 determines a change in the estimated doctor arrival time, location notification program 112 may send a follow-up notification which indicates the change. In one embodiment, the notification may include additional detail. For example, if location notification program 112 determines from the doctor's location and schedule that the doctor is in surgery in the surgical ward and will be there for an additional two hours, then location notification program 112 can notify the patient advocate that the doctor is currently in surgery and will not be available for at least two hours. In another embodiment, if location notification program 112 determines patient advocate device 108 is in the hospital, then location notification program 112 can send a notification when location notification program 112 determines doctor device 104 arrives at the hospital.

In one embodiment, if, after receiving the notification, the patient advocate determines they cannot be in the patient's room at the estimated doctor arrival time, then location notification program 112 can offer the patient advocate, via user interface 106, the ability to schedule a video chat with the doctor. The video chat may be scheduled for the time the doctor is in the patient's room or another time convenient to both the patient advocate and the doctor. In a further embodiment, if, after receiving the notification, the patient advocate determines they cannot be in the patient's room at the estimated doctor arrival time, then location notification program 112 can offer the patient advocate, via user interface 106, the ability to request that the doctor re-schedule the arrival time. For example, if the patient advocate determines he will arrive ten minutes after the estimated doctor arrival time, then location notification program 112 can provide a window for the patient advocate to request the doctor visit another patient first. In both embodiments, location notification program 112 notifies the doctor of the situation and enables the doctor to provide a response. In yet another embodiment, if, after receiving the notification, the patient advocate determines they cannot be in the patient's room at the estimated doctor arrival time, then location notification program 112 can offer the patient advocate, via user interface 106, the ability to request a meeting with a backup doctor.

FIG. 3 depicts a block diagram of components of server computer 110 within distributed data processing environment 100 of FIG. 1, in accordance with an embodiment of the present invention. It should be appreciated that FIG. 3 provides only an illustration of one implementation and does not imply any limitations with regard to the environments in which different embodiments can be implemented. Many modifications to the depicted environment can be made.

Server computer 110 can include processor(s) 304, cache 314, memory 306, persistent storage 308, communications unit 310, input/output (I/O) interface(s) 312 and communications fabric 302. Communications fabric 302 provides communications between cache 314, memory 306, persistent storage 308, communications unit 310, and input/output (I/O) interface(s) 312. Communications fabric 302 can be implemented with any architecture designed for passing data and/or control information between processors (such as microprocessors, communications and network processors, etc.), system memory, peripheral devices, and any other hardware components within a system. For example, communications fabric 302 can be implemented with one or more buses.

Memory 306 and persistent storage 308 are computer readable storage media. In this embodiment, memory 306 includes random access memory (RAM). In general, memory 306 can include any suitable volatile or non-volatile computer readable storage media. Cache 314 is a fast memory that enhances the performance of processor(s) 304 by holding recently accessed data, and data near recently accessed data, from memory 306.

Program instructions and data used to practice embodiments of the present invention, e.g., location notification program 112 and database 114, are stored in persistent storage 308 for execution and/or access by one or more of the respective processor(s) 304 of server computer 110 via cache 314. In this embodiment, persistent storage 308 includes a magnetic hard disk drive. Alternatively, or in addition to a magnetic hard disk drive, persistent storage 308 can include a solid-state hard drive, a semiconductor storage device, a read-only memory (ROM), an erasable programmable read-only memory (EPROM), a flash memory, or any other computer readable storage media that is capable of storing program instructions or digital information.

The media used by persistent storage 308 may also be removable. For example, a removable hard drive may be used for persistent storage 308. Other examples include optical and magnetic disks, thumb drives, and smart cards that are inserted into a drive for transfer onto another computer readable storage medium that is also part of persistent storage 308.

Communications unit 310, in these examples, provides for communications with other data processing systems or devices, including resources of doctor device 104 and patient advocate device 108. In these examples, communications unit 310 includes one or more network interface cards. Communications unit 310 may provide communications through the use of either or both physical and wireless communications links. Location notification program 112, database 114, and other programs and data used for implementation of the present invention, may be downloaded to persistent storage 308 of server computer 110 through communications unit 310.

I/O interface(s) 312 allows for input and output of data with other devices that may be connected to server computer 110. For example, I/O interface(s) 312 may provide a connection to external device(s) 316 such as a keyboard, a keypad, a touch screen, a microphone, a digital camera, and/or some other suitable input device. External device(s) 316 can also include portable computer readable storage media such as, for example, thumb drives, portable optical or magnetic disks, and memory cards. Software and data used to practice embodiments of the present invention, e.g., location notification program 112 and database 114 on server computer 110, can be stored on such portable computer readable storage media and can be loaded onto persistent storage 308 via I/O interface(s) 312. I/O interface(s) 312 also connect to a display 318.

Display 318 provides a mechanism to display data to a user and may be, for example, a computer monitor. Display 318 can also function as a touchscreen, such as a display of a tablet computer.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product. The computer program product may include a computer readable storage medium (or media) having computer readable program instructions thereon for causing a processor to carry out aspects of the present invention.

The computer readable storage medium can be any tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, a special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, a segment, or a portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A method for determining doctor availability, the method comprising:
receiving, by one or more computer processors, a request for doctor availability in a patient's hospital room from a patient advocate;
determining, by the one or more computer processors, a current location of a doctor's mobile computing device;
determining, by the one or more computer processors, based, at least in part, on the current location of the doctor's mobile computing device, an arrival time of the doctor in the patient's hospital room; and
sending, by the one or more computer processors, a notification to the patient advocate of the arrival time of the doctor in the patient's hospital room.

2. The method of claim 1, further comprising:
determining, by the one or more computer processors, a current location of a patient advocate's mobile computing device; and
determining, by the one or more computer processors, a travel time of the patient advocate from the current location of the patient advocate's mobile computing device to the patient's hospital room.

3. The method of claim 1, further comprising:
acquiring, by the one or more computer processors, a schedule associated with the doctor; and
determining, by the one or more computer processors, based, at least in part, on the current location of the doctor's mobile computing device and on the acquired schedule, the arrival time of the doctor in the patient's hospital room.

4. The method of claim 1, wherein determining the arrival time of the doctor in the patient's hospital room further comprises:
detecting, by the one or more computer processors, patterns of geospatial movement of the doctor's mobile computing device; and
determining, by the one or more computer processors, based, at least in part, on the current location of the doctor's mobile computing device and on the detected patterns, the arrival time of the doctor in the patient's hospital room.

5. The method of claim 1, wherein determining the arrival time of the doctor in the patient's hospital room further comprises accessing, by the one or more computer processors, a source of dynamic data.

6. The method of claim 1, wherein the notification to the patient advocate of the arrival time of the doctor in the patient's hospital room includes one or more of: an estimated arrival time of the doctor, a current location of the doctor, or a travel time to the patient's hospital room.

7. The method of claim 1, wherein the arrival time of the doctor in the patient's hospital room includes a confidence level, and wherein computation of the confidence level is based on at least one of: a learned pattern, a current location of the doctor's mobile computing device, or an acquired schedule.

8. A computer program product for determining doctor availability, the computer program product comprising:
one or more computer readable storage devices and program instructions stored on the one or more computer readable storage devices, the stored program instructions comprising:
program instructions to receive a request for doctor availability in a patient's hospital room from a patient advocate;
program instructions to determine a current location of a doctor's mobile computing device;
program instructions to determine, based, at least in part, on the current location of the doctor's mobile computing device, an arrival time of the doctor in the patient's hospital room; and
program instructions to send a notification to the patient advocate of the arrival time of the doctor in the patient's hospital room.

9. The computer program product of claim 8, the stored program instructions further comprising:
program instructions to determine a current location of a patient advocate's mobile computing device; and
program instructions to determine a travel time of the patient advocate from the current location of the patient advocate's mobile computing device to the patient's hospital room.

10. The computer program product of claim 8, the stored program instructions further comprising:
program instructions to acquire a schedule associated with the doctor; and
program instructions to determine, based, at least in part, on the current location of the doctor's mobile computing device and on the acquired schedule, the arrival time of the doctor in the patient's hospital room.

11. The computer program product of claim 8, wherein the program instructions to determine the arrival time of the doctor in the patient's hospital room comprise:
program instructions to detect patterns of geospatial movement of the doctor's mobile computing device; and
program instructions to determine, based, at least in part, on the current location of the doctor's mobile computing device and on the detected patterns, the arrival time of the doctor in the patient's hospital room.

12. The computer program product of claim 8, wherein the program instructions to determine the arrival time of the doctor in the patient's hospital room comprise program instructions to access a source of dynamic data.

13. The computer program product of claim 8, wherein the notification to the patient advocate of the arrival time of the doctor in the patient's hospital room includes one or more of: an estimated arrival time of the doctor, a current location of the doctor, or a travel time to the patient's hospital room.

14. The computer program product of claim 8, wherein the arrival time of the doctor in the patient's hospital room includes a confidence level, and wherein computation of the confidence level is based on at least one of: a learned pattern, a current location of the doctor's mobile computing device, or an acquired schedule.

15. A computer system for determining doctor availability, the computer system comprising:
one or more computer processors;
one or more computer readable storage device;
program instructions stored on the one or more computer readable storage devices for execution by at least one of the one or more computer processors, the stored program instructions comprising:
program instructions to receive a request for doctor availability in a patient's hospital room from a patient advocate;
program instructions to determine a current location of a doctor's mobile computing device;
program instructions to determine, based, at least in part, on the current location of the doctor's mobile computing device, an arrival time of the doctor in the patient's hospital room; and
program instructions to send a notification to the patient advocate of the arrival time of the doctor in the patient's hospital room.

16. The computer system of claim 15, the stored program instructions further comprising:
program instructions to determine a current location of a patient advocate's mobile computing device; and
program instructions to determine a travel time of the patient advocate from the current location of the patient advocate's mobile computing device to the patient's hospital room.

17. The computer system of claim 15, the stored program instructions further comprising:
program instructions to acquire a schedule associated with the doctor; and
program instructions to determine, based, at least in part, on the current location of the doctor's mobile computing device and on the acquired schedule, the arrival time of the doctor in the patient's hospital room.

18. The computer system of claim 15, wherein the program instructions to determine the arrival time of the doctor in the patient's hospital room comprise:
program instructions to detect patterns of geospatial movement of the doctor's mobile computing device; and
program instructions to determine, based, at least in part, on the current location of the doctor's mobile computing device and on the detected patterns, the arrival time of the doctor in the patient's hospital room.

19. The computer system of claim 15, wherein the program instructions to determine the arrival time of the doctor in the patient's hospital room comprise program instructions to access a source of dynamic data.

20. The computer system of claim 15, wherein the arrival time of the doctor in the patient's hospital room includes a confidence level, and wherein computation of the confidence level is based on at least one of: a learned pattern, a current location of the doctor's mobile computing device, or an acquired schedule.
